(19) United States
(12) Patent Application Publication
(10) Pub. No.: US 2009/0204531 A1
(43) Pub. Date: Aug. 13, 2009

(54) FINANCIAL MANAGEMENT AND PROFESSIONAL REFERRAL SOFTWARE

(76) Inventor: John Johnson, Olympia, WA (US)

Correspondence Address: Ruttler Law PLLC;One Union Square, 600 University Street, Suite 1919, Seattle, WA, 98101, US

(21) Appl. No.: 12/369,191

(22) Filed: Feb. 11, 2009

Related U.S. Application Data
(60) Provisional application No. 61/027,773, filed on Feb. 11, 2008.
(60) Provisional application No. 61/038,703, filed on Mar. 21, 2008.

(51) Int. Cl. G06Q 40/00

(52) U.S. Cl. 705/35

(57) ABSTRACT

This invention relates generally to software, and more specifically, to systems and methods for providing financial management and professional referral software. In one embodiment, the invention includes a software application that performs the steps of establishing an account for an individual; accepting assets for the individual, the assets being associated with the account; accepting liabilities for the individual, the liabilities being associated with the account; defining goals for the individual, the goals being associated with the account; defining a budget for the individual, the budget being associated with the account; receiving financial transactions for the individual, the financial transactions being associated with the account; reconciling the budget with the financial transactions; reconciling the financial statements with the financial transactions; reconciling the goals; summarizing the budget, financial statements, and goals for the individual; receiving a professional service provider; associating the professional service provider with a trigger event; evaluating any of the budget, financial statements, and the goals to determine whether the trigger event has occurred; and upon occurrence of the trigger event, referring the professional service provider to the individual.

### PRIORITY CLAIM

This application claims the benefit of U.S. provisional patent application Ser. No. 61/027,773 filed Feb. 11, 2008 (our ref. JJHN-1-1001) and U.S. provisional patent application Ser. No. 61/038,703 filed Mar. 21, 2008 (our ref. JJHN-1-1001-1). The foregoing applications are incorporated by reference in their entirety as if fully set forth herein.

### FIELD OF THE INVENTION

This invention relates generally to software, and more specifically, to systems and methods for providing financial management and professional referral software.

### BACKGROUND

Complete financial management includes monitoring day-to-day financial transactions; budgeting; analyzing income statements, cash flow statements, and balance sheets; defining and adhering to goals; and consulting with professional advisors.

Budgeting involves constraints to ongoing spending while income statements and cash flow statements provide snapshots of actual spending habits for a given time period. Accordingly, a budget sets forth desired spending habits and income and cash flow statements provide tools to analyze actual spending habits. The difference between income statements and cash flow statements is that income statements take into account earned revenue that has yet to be collected as well as incurred expenses that have yet to be paid, whereas cash flow statements merely compare incoming cash with outgoing cash. Accordingly, a cash flow statement is useful to determine whether there is enough cash to pay bills; however, it doesn't reflect unpaid bills or expected future cash sources. A balance sheet reflects assets and liabilities that have accumulated over time based upon ongoing spending habits. These assets and liabilities can include real estate, stock, cash, credit card debt, student loans, car loans, and mortgages. Therefore, a balance sheet can indicate whether too many liabilities are being incurred or whether there are too few assets; this information can assist with future budget planning. Accordingly, these financial management elements are quite interrelated. For instance, a balance sheet and past income and cash flow statements can assist in developing a budget. With a defined budget, spending habits can be analyzed to determine conformity with the budget. Income statements and cash flow statements can then be used to analyze spending patterns for a given period of time and a revised balance sheet can show the long term effects of the spending habits. Clearly then, neglect of one of the financial management elements can have direct and adverse consequences to the others. For example, a focus on budgeting without attention to how spending habits affect a balance sheet can result in insolvency if the budget permits acquisition of too many liabilities. Further, attention to an income statement without regard to cash flows can result in an inability to pay current bills if too much reliance is placed on uncollected debts. Additionally, asset allocation planning without attention to budgeting can result in a lack of assets to actually allocate if the budget permits wasteful spending.

In addition to budgeting, income statements, cash flow statements, and balance sheets, defining and adhering to financial goals and access to professional advisors also play important financial management roles. After all, acquiring, organizing, and presenting important financial information through the elements above is virtually useless without additional interpretation. For instance, while it is convenient to know what percentage of income is being spent on debt service, what percentage of assets are fixed, and whether there is budget adherence, this information alone does not indicate whether debt service should be reduced, whether more liquid assets should be obtained, or whether the budget needs to be modified. Interpretation of this information is therefore necessary in order to make such determinations and that interpretation can be accomplished in part by defining goals and monitoring progress towards those goals. If a goal is to reduce debt, decisions can be made to adjust a budget and spending habits in furtherance of that goal. Likewise, if a goal is to save for college or acquire a vacation property, decisions can be made to adjust spending habits accordingly. Furthermore, obtaining professional advice when defining budgets, analyzing financial statements, defining goals, or evaluating goals can further assist in making sound and informed decisions.

Despite the fact that few would disagree that complete financial management includes monitoring day-to-day financial transactions; budgeting; analyzing income statements, cash flow statements, and balance sheets; defining and adhering to goals; and consulting with professional advisors, no single tool has been developed to simultaneously address each component. Instead, the best case scenario is that individuals use certain tools for budgeting and other tools for producing financial statements. Goals are developed independently and are manually reconciled with budgets and financial statements. Professional advisors are consulted using a separate phone directory or a personal referral when problems arise or issues become too complicated. Given such disparate tools and the potential complexity of financial management, it isn't surprising to learn that individuals often have difficulty managing their finances, saving adequately, and investing appropriately.

Opposite to the individual having financial management needs are professional advisors having the education, experience, and credentials to assist with those needs. Such professional advisors can include financial advisors, accountants, attorneys, insurance agents, mortgage brokers, lenders, architects, doctors, and many others. Typically, individuals contact these professional advisors using phone or internet directories or through personal referrals. This traditional method suffers from being time-consuming, laborious, and inefficient. Furthermore, it assumes that individuals know when and whether to contact a particular professional advisor. Accordingly, because no tool has been developed that seamlessly determines when and what professional advice is needed and automatically introduces an appropriate professional advisor, many individuals forgo advice and unwisely make important and complex financial management decisions without professional guidance.

Accordingly, although desirable results have been achieved, there exists much room for improvement. What is needed then are systems and methods for providing financial management and professional referral software.

### SUMMARY

This invention relates generally to software, and more specifically, to systems and methods for providing financial management and professional referral software. In one embodiment, the invention includes a software application that performs the steps of establishing an account for an individual; accepting assets for the individual, the assets being associated with the account; accepting liabilities for the individual, the liabilities being associated with the account; defining goals for the individual, the goals being associated with the account; defining a budget for the individual, the budget being associated with the account; receiving financial transactions for the individual, the financial transactions being associated with the account; reconciling the budget with the financial transactions; reconciling the financial statements with the financial transactions; reconciling the goals; summarizing the budget, financial statements, and goals for the individual; receiving a professional service provider; associating the professional service provider with a trigger event; evaluating any of the budget, financial statements, and the goals to determine whether the trigger event has occurred; and upon occurrence of the trigger event, referring the professional service provider to the individual.

### BRIEF DESCRIPTION OF THE DRAWINGS

Embodiments of the present invention are described in detail below with reference to the following drawings:

FIG. 1 is a block diagram of a method for initializing an account in financial management and professional referral software, in accordance with an embodiment of the invention;

FIG. 2 is a block diagram of a method for analyzing an account in financial management and professional referral software, in accordance with an embodiment of the invention;

FIG. 3 is a block diagram of a method for providing a professional service referral in financial management and professional referral software, in accordance with an embodiment of the invention;

FIG. 4 is a block diagram of a method for associating with a professional service provider in financial management and professional referral software, in accordance with an embodiment of the invention;

FIG. 5 is a software component diagram of financial management and professional referral software, in accordance with an embodiment of the invention;

FIG. 6 is a system diagram of financial management and professional referral software being implemented over a computer network, in accordance with an embodiment of the invention;

FIG. 7 is a block diagram of a method for providing job referrals in financial management and professional referral software, in accordance with an embodiment of the invention;

FIG. 8 is a block diagram of a method for populating a wizard for preparing government taxes in financial management and professional referral software, in accordance with an embodiment of the invention;

FIG. 9 is a block diagram of a method for matching accounts based on compared financial statements in financial management and professional referral software, in accordance with an embodiment of the invention;

FIG. 10 is a block diagram of a method for populating a navigational system with business names from previous purchases in financial management and professional referral software, in accordance with an embodiment of the invention;

FIG. 11 is a block diagram of a method for presenting offers in financial management and professional referral software, in accordance with an embodiment of the invention;

FIG. 12 is a block diagram of a method for presenting real estate listings in financial management and professional referral software, in accordance with an embodiment of the invention;

APPENDIX A is a list of sample registry categories in financial management and professional referral software, in accordance with an embodiment of the invention;

APPENDIX B is a list of sample balance sheet categories in financial management and professional referral software, in accordance with an embodiment of the invention;

APPENDIX C is a list of sample income statement categories in financial management and professional referral software, in accordance with an embodiment of the invention; and

APPENDIX D are screen shots of financial management and professional referral software, in accordance with an embodiment of the invention.

### DETAILED DESCRIPTION

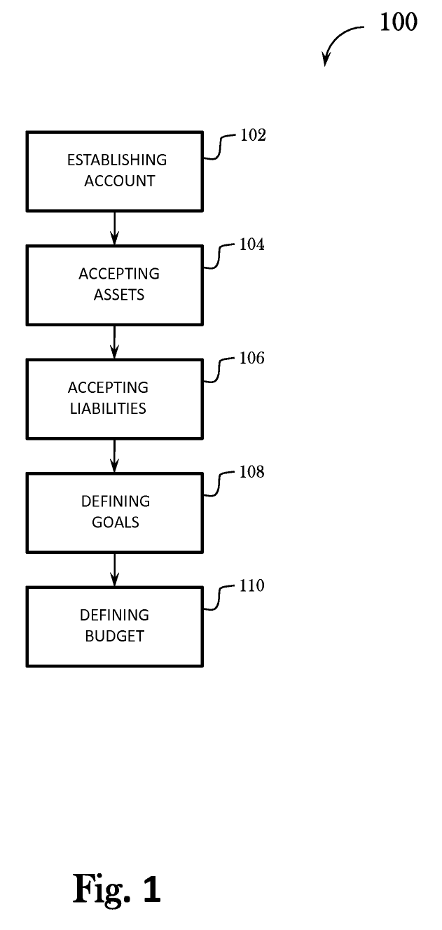

This invention relates generally to software, and more specifically, to systems and methods for providing financial management and professional referral software. Specific details of certain embodiments of the invention are set forth in the following description and in FIG. 1-12 and Appendices A-D to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a block diagram of a method for initializing an account in financial management and professional referral software, in accordance with an embodiment of the invention. In one embodiment, method 100 includes establishing an account at block 102, accepting assets at block 104, accepting liabilities at block 106, defining goals at block 108, and defining a budget at block 110. The establishing an account at block 102 includes receiving an individual's name, demographic information, username, and password through a user interface and storing this information, such as in a database. Additional information may be received and stored including information on a referral source. The accepting assets at block 104 includes receiving the individual's assets through the user interface and associating the assets with the account established at block 102. Assets are anything of value and can include cash; funds in a checking account, a savings account, a money market account, or a certificate of deposit account; treasury bills; stocks; bonds; mutual funds; annuities; private equity; life insurance; trusts; real estate; vehicles; boats; planes; art; antiques; jewelry; or some other thing of value. In one particular embodiment, the user interface includes a wizard to facilitate comprehensive receipt of the individual's assets. The accepting liabilities at block 106 includes receiving the individual's liabilities through the user interface and associating the liabilities with the account established at block 102. Liabilities are any obligation and can include mortgages, home equity loans, auto loans, personal loans, student loans, insurance premiums, credit cards, taxes, or any other obligation. The defining goals at block 108 includes associating the individual's financial goals with the assets and liabilities accepted at blocks 104 and 106, respectively. In one particular embodiment, the goals are pre-defined recommended goals for achieving financial success. For example, the goals can include first saving a safety reserve amount, second eliminating non-auto and non-home related debt, third eliminating auto related debt, fourth saving an additional emergency fund amount, fifth saving for retirement, and sixth eliminating home related debt. Many other pre-defined recommended goals are possible. In yet another particular embodiment, the goals are partially or wholly customizable through the user interface. Whether the goals are automatically pre-defined or customized, they are associated with the assets and liabilities accepted at block 104 and 106, respectively, to permit ongoing evaluation as to whether the goals have been achieved. For instance, the saving a safety reserve amount goal can be associated with a savings account in the assets; the eliminating non-auto and non-home related debt goal can be associated with a credit card in the liabilities; the eliminating auto related debt goal can be associated with an auto loan in the liabilities; the saving an additional emergency fund goal can be associated with a money market account in the assets; the saving for retirement goal can be associated with a mutual fund in the assets; and the eliminating home related debt can be associated with a mortgage in the liabilities. The association of the goals with the assets and liabilities can be automatic or accomplished partially or wholly through the user interface. The defining a budget at block 110 includes establishing spending constraints to facilitate progress towards the goals defined at block 108 and associating the budget with the account established at block 102. In one particular embodiment, the budget is defined by receiving budget amounts for budget categories through the user interface; although, the budget can be automatically provided in whole or in part based upon the assets and liabilities accepted at block 104 and 106, respectively, and the goals defined at block 108. For example, the budget amounts and categories can include an amount for income and amounts for food, entertainment, clothing, utilities, fuel, parking, savings, investing, mortgage payments, auto loans, student loans, insurance, credit cards, and taxes.

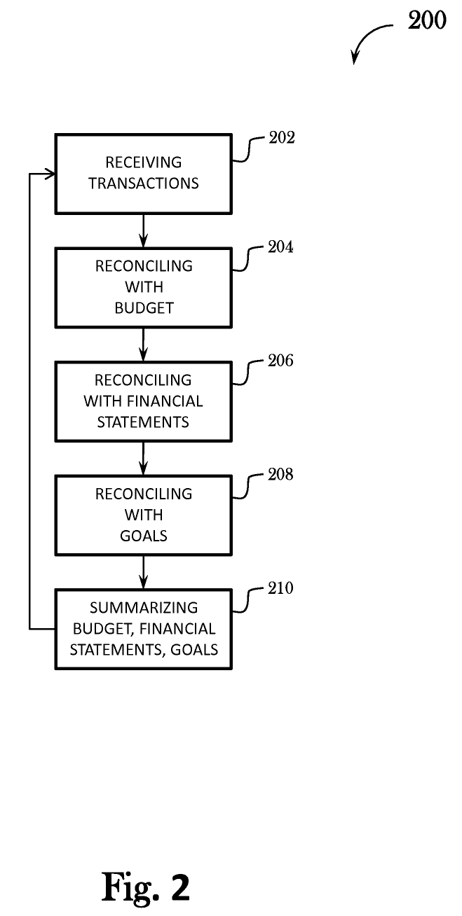

FIG. 2 is a block diagram of a method for analyzing an account in financial management and professional referral software, in accordance with an embodiment of the invention. In one embodiment, method 200 includes receiving transactions at block 202, reconciling the transactions with the budget at block 204, reconciling the transactions with financial statements at block 206, reconciling the transactions with goals at block 208, and summarizing the budget, financial statements, and goals at block 210. Method 200 is operable in coordination with method 100. The receiving transactions at block 202 includes receiving debits and credits for the account established in method 100 and associating the debits and credits with the account. The transactions can be received manually through the user interface or can be received partially or wholly automatically through electronic or wireless communication with financial institutions or intermediaries such as CASH EDGE or YODLEE. The transactions reflect ongoing income and expenditures for the account. For instance, credits include any income including earned income, dividends, capital gains, gifts, inheritances, or other income. Debits include any expense including debt servicing, asset acquisitions, or other incidental expenses such as food, entertainment, clothing, utilities, fuel, parking, or other expense (APPENDIX A). The reconciling the transactions with the budget at block 204 includes associating each transaction with the appropriate budget category established in method 100 to permit transactions amounts within each budget category to be compared against their defined budget amounts. For example, gasoline expenditures can be associated with a fuel budget category, dining-out expenditures can be associated with an entertainment category, and stock purchases can be associated with an investment category. The transactions can be manually associated with the appropriate budget category through the user interface or can be partially or wholly automatically associated with the appropriate budget category. The summarizing the budget at block 210 includes comparing the transaction amounts with the budget amounts for each budget category and providing raw data, reports, charts, or graphs that are usable to determine conformity with the established budget. The reconciling the transactions with financial statements at block 206 includes associating each transaction with appropriate income statement categories, balance sheet categories, and cash flow statement categories. The transactions can be manually associated using a user interface or can be partially or wholly automatically associated with the appropriate financial statement categories. An income statement provides a snapshot of income and expenses for a given time period and reflects earned income and incurred expenses regardless of actual receipt or disbursement of money. Income statement categories include income such as earned income, dividends, capital gains, gifts, and inheritances and expenses such as debt service, asset acquisitions, food, entertainment, clothing, utilities, fuel, parking (APPENDIX C). A balance sheet provides a cumulative summary of assets and liabilities that have accrued over time through ongoing transactions. Balance sheet categories include assets such as cash, checking accounts, savings accounts, money market accounts, certificate of deposits, treasury bills, stocks, bonds, mutual funds, annuities, private equity, life insurance, trusts, real estate, vehicles, boats, planes, art, antiques, and jewelry and liabilities such as mortgages, home equity loans, auto loans, personal loans, student loans, insurance premiums, credit cards, taxes, or other assets or liabilities (APPENDIX B). A cash flow statement provides a snapshot of incoming cash receipts and outgoing cash payments without considering expected receipts or future obligations. Cash flow statement categories can include the same categories as those in the income statement. The summarizing the financial statements at block 210 includes providing the income statement, balance sheet, and cash flow statement through raw data, reports, charts, or graphs. The reconciling the goals at block 208 includes evaluating progress towards accomplishing the goals established in method 100. For each established goal, the goal amount is compared with its associated asset or liability to determine whether progress has been made toward the goal or whether the goal has been fulfilled. Extending the examples discussed in reference to method 100, the savings account balance would be compared with the goal of saving a safety reserve amount to determine whether progress had been made towards saving a desired amount. The credit card balances would be compared with the goal of eliminating non-auto and non-home related debt to determine whether progress had been made towards eliminating credit card debt. The auto loan balance would be compared with the goal of eliminating auto related debt to determine whether progress had been made towards the eliminating auto loan debt. The money market account would be compared with the goal of saving an additional emergency fund of six months of income to determine whether progress had been made towards saving a desired amount. The mutual fund would be compared with the goal of saving a particular amount for retirement to determine whether progress had been made towards retirement savings. And, the mortgage balance would be compared with the goal of eliminating home related debt to determine whether progress had been made towards eliminating mortgage debt. In certain embodiments, the goals are associated with transactions, financial statements, budget, or other goals such as ‘wish list’ type goals and the goals are reconciled accordingly. The summarizing the goals at block 210 includes providing raw data, checklists, reports, charts, or graphs that are usable to determine progress towards the goals. Accordingly, method 200 receives transactions for an account, summarizes those transactions in the form of financial statements, and tracks progress towards goals.

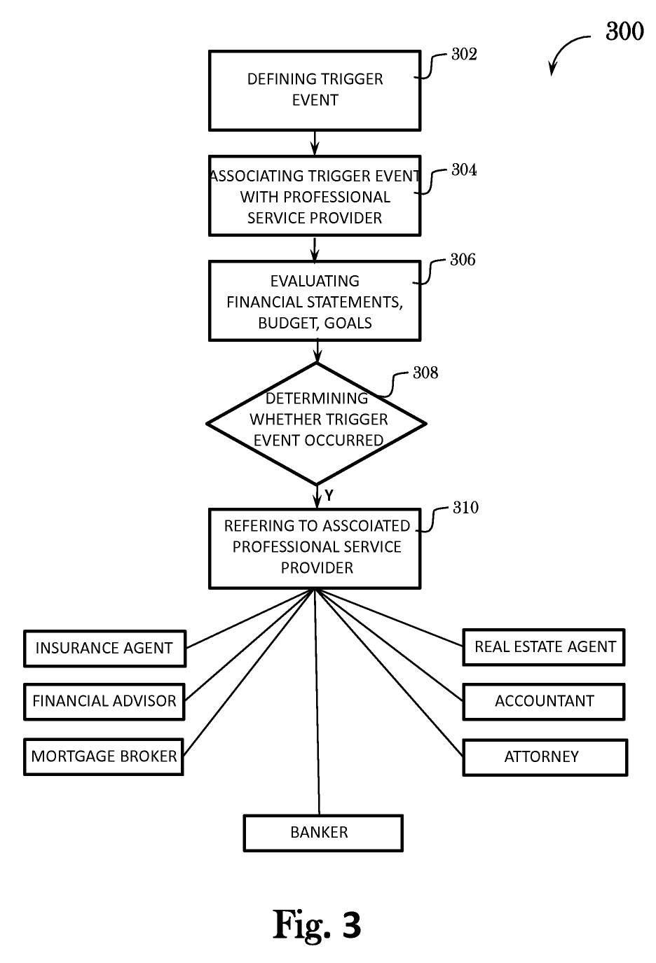

FIG. 3 is a block diagram of a method for providing a professional service referral in financial management and professional referral software, in accordance with an embodiment of the invention. In one embodiment, method 300 includes defining a trigger event at block 302, associating the trigger event with a professional service provider at block 304, evaluating financial statements, budget, and goals at block 306, determining whether the trigger event occurred at block 308, and referring to the associated professional service provider when the trigger event occurs at block 310. Method 300 is operable in coordination with methods 100 and 200. The defining the trigger event at block 302 includes receiving a test for analyzing financial statements, budget, or goals that are associated with an account to determine when a potential need for a professional service arises. Example tests include determining whether liabilities are greater than assets, whether assets are large enough to result in estate taxes, whether assets include a certain amount of investible savings, whether home equity exceeds credit card and other non-mortgage debts, whether home equity exceeds deficiencies of an emergency fund, whether spending over budget, and whether a goal is present or has been fulfilled. While these are some examples of trigger events that indicate a potential need for professional services, many more exist or can be developed for any reason why a potential need for a professional service would arise. The associating the trigger event with a professional service provider at block 304 includes defining a professional service provider to be referred upon occurrence of the trigger event. Professional service providers can include insurance agents, financial advisors, mortgage brokers, bankers, real estate agents, accountants, attorneys, financial counselors, and any other service provider. The professional service provider associated with the trigger event possesses the skills to address the potential need that would result in the trigger event. For example, an insurance agent can be associated with the trigger event of liabilities being greater than assets given that that negative net worth indicates a potential need for life insurance. Similarly, a financial advisor can be associated with the trigger event of assets being large enough to result in estate taxes given that excessive assets indicates a potential need for tax planning. Also, a mortgage broker can be associated with the trigger events of home equity exceeding credit card debt or home equity being in excess of deficiencies of an emergency fund given that such events indicate a potential need for refinancing. And, a financial counselor can be associated with the trigger event of spending exceeding budget given that excessive spending indicates a potential need for spending advice. Further, a real estate agent can be associated with the trigger event of the presence of a goal to purchase or sell a home. Likewise, an attorney can be associated with the trigger event of the presence of a goal to prepare a testamentary will. The evaluating financial statements, budget, or goals at block 306 includes determining whether the trigger event has occurred for an account at block 308. Accordingly, the test for the trigger event is analyzed against appropriate data from the income statement, cash flow statement, balance sheet, budget, or goals for an account to determine whether the trigger event has occurred. In the examples above, (1) the balance sheet would be evaluated to determine whether the trigger event of debts being greater than assets has occurred; (2) assets on the balance sheet would be evaluated to determine whether the trigger event of assets being large enough to result in estate taxes has occurred; (3) cash, savings, and investment accounts from the balance sheet would be evaluated to determine whether the trigger event of investible savings has occurred; (4) home value, mortgage debt, credit card debt, cash, and savings accounts from the balance sheet would be evaluated to determine whether the trigger event of home equity exceeding credit card debt has occurred or whether the trigger event of home equity exceeding deficiencies of an emergency fund has occurred; (5) the budget would be evaluated to determine whether the trigger event of spending exceeding budget has occurred; and (6) the goals would be evaluated to determine whether the trigger events of goals to purchase a home or prepare a will were present. When other trigger events are defined, any other account data can be evaluated as needed. When the trigger event occurs at block 308, the referring to the associated professional service provider at block 310 is performed. The referral is a notification to the individual associated with the account that a professional service is potentially needed along with contact information for the professional service provider. Accordingly, method 300 provides an automatic and timely referral for a professional service provider that is based on needs determined by an individual's financial related information.

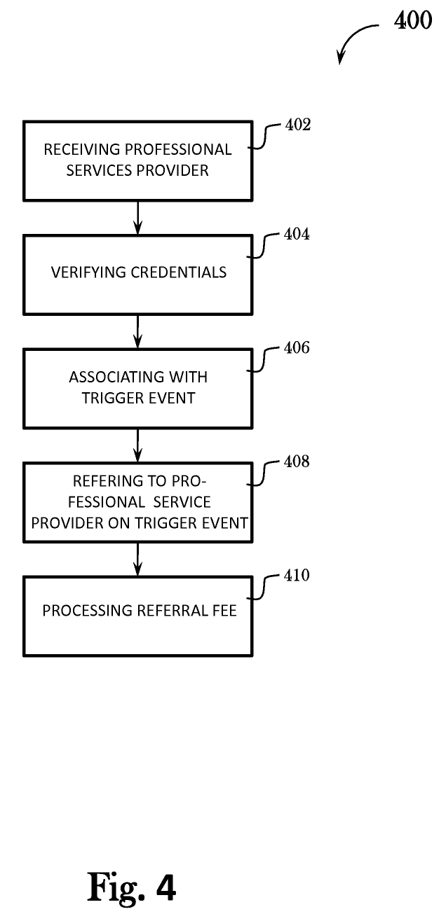

FIG. 4 is a block diagram of a method for associating with a professional service provider in financial management and professional referral software, in accordance with an embodiment of the invention. In one embodiment, method 400 includes receiving a professional service provider at block 402, verifying the professional service provider's credentials at block 404, associating the professional service provider with a trigger event at block 406, referring to the professional service provider on occurrence of the trigger event at block 408, and processing a referral fee at block 410. Method 400 is operable in coordination with method 300. The receiving the professional service provider at block 402 includes a professional service provider providing his or her name, demographics, contact information, credentials, payment information, and desired trigger event. As discussed further in reference to method 300, occurrence of the trigger event indicates a potential need for professional services. The desired trigger event can be selected from pre-defined standard trigger events or can be customized to target specific needs. The professional service provider provides this information directly through a user interface or indirectly through an intermediary such as a customer service representative. The verifying the professional service provider's credentials at block 404 includes determining whether the credentials provided by the professional service provider are authentic. For example, educational degrees, certificates, memberships, and references can be confirmed either directly through electronic communication with appropriate entities or indirectly through an intermediary such as a service representative. As discussed further in reference to method 300, the associating the professional service provider with a trigger event at block 406 includes associating the professional service provider with the desired trigger event provided at block 402 such that a referral is made to the professionals service provider when the desired trigger event occurs. The referring to the professional service provider on occurrence of the trigger event at block 408 includes evaluating financial statements, a budget, or goals associated with one or more accounts to determine whether the trigger event has occurred. Upon occurrence of the trigger event, a referral is provided to the individual associated with the account that provides the professional service potentially needed and the name, demographics, contact information, and credentials of the professional service provider associated with the trigger event. The referral is provided via email or other digital, analog, wire based, or wireless communication means and is usable by the individual to contact the professional service provider if desired. The processing a referral fee at block 410 includes charging the professional service provider for the referral using the payment information provided at block 402. In certain embodiments, the referral fee is paid only upon the professional service provider being contacted by the individual or providing services to the individual.

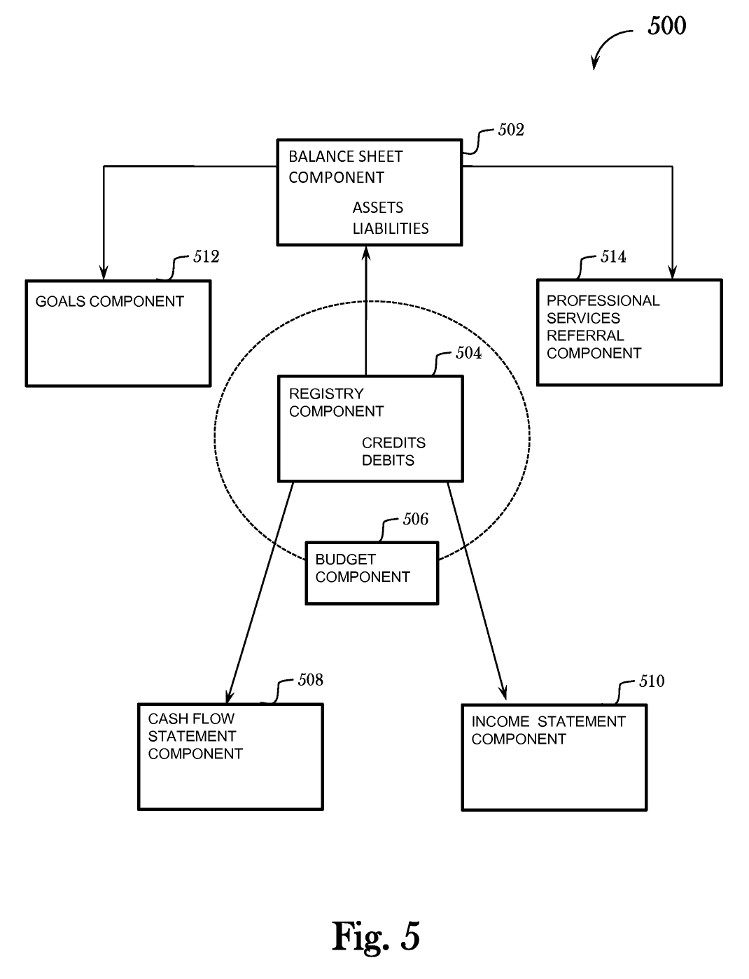

FIG. 5 is a software component diagram of financial management and professional referral software, in accordance with an embodiment of the invention. In one embodiment, software 500 includes a balance sheet component 502, a registry component 504, a budget component 506, a cash flow statement component 508, an income statement component 510, a goals component 512, and a professional services referral component 514. The software 500 is programmable in any programming language. Financial transactions for an individual's account, including debits and credits (APPENDIX A), are stored in the registry component 504. The debits and credits reflect ongoing income and purchases for the individual and serve as the fundamental building blocks in the software 500. As such, the financial transactions within the registry component 504 are accessed by the budget component 506, the cash flow statement component 508, the income statement component 510, and the balance sheet component 502 for analysis. Further, the goals component 512 utilizes the financial transactions either directly or indirectly, such as through the balance sheet component, to determine progress towards goals. Similarly, the professional services referral component 514 utilizes the financial transactions either directly or indirectly, such as through the balance sheet component or goals component, to determine whether trigger events have occurred. The financial transactions in the registry component 504 are acquired manually through a user interface or automatically through digital communication with a financial institution or intermediary such as CASH EDGE or YODLEE. A budget for the individual's account, including budget categories and budget amounts, is stored in the budget component 506. The budget sets forth desired spending constraints for a given time period and can be defined manually through a user interface or automatically by analyzing past financial transactions. The budget component 506 accesses the individual's financial transactions in the registry component 504, organizes the financial transactions, and provides budget adherence data in the form of raw data, charts, graphs, or reports for the individual. The organization of the financial transactions into corresponding budget categories occurs manually through a user interface or automatically. The cash flow statement component 508 and the income statement component 510 access the individual's financial transactions in the registry component 504, organize the financial transactions, and provide data in the form of a cash flow statement and income statement, respectively. The cash flow statement provides a summary of revenue actually received against expenses actually paid for a given time period. Revenue includes sources such as earned income, dividends, capital gains, gifts, and inheritances and expenses include items such as debt service payments, asset acquisitions, food, entertainment, clothing, utilities, fuel, and parking (APPENDIX C). Income statements differ from cash flow statements in that income statements also include income not actually received and expenses not yet paid. Cash flow statements and income statements differ from budgets in that budgets set forth desired spending constraints whereas cash flow statements and income statements provide data on actual spending habits. Assets and liabilities for the individual's account are stored in the balance sheet component 502. Assets and liabilities are items of value and obligations, respectively, which have accumulated over time as a result of the individual's ongoing financial transactions (APPENDIX B). Assets and liabilities are initially provided by the individual using a user interface; however, the balance sheet component 502 subsequently populates the assets and liabilities by accessing the registry component 504, the cash flow statement component 508, or the income statement component 510. Goals for the individual's account are stored in the goals component 512. Goals are financial milestones for the individual such as saving a safety reserve amount, eliminating non-auto and non-home related debt, eliminating auto related debt, saving an six month emergency fund, saving for retirement, eliminating mortgage debt, purchasing furniture, selling a home, acquiring rental property, or having a will drafted. Goals can be provided for the individual or customized by the individual and are associated with assets and liabilities in the balance sheet component 502. For example, the saving a safety reserve amount goal can be associated with a savings account in the assets; the eliminating non-auto and non-home related debt goal can be associated with a credit card in the liabilities; the eliminating auto related debt goal can be associated with an auto loan in the liabilities; the saving an additional emergency fund goal can be associated with a money market account in the assets; the saving for retirement goal can be associated with a mutual fund in the assets; and the eliminating home related debt can be associated with a mortgage in the liabilities. The goals component 512 accesses the assets and liabilities in the balance sheet component 502 to evaluate whether progress is being made towards particular goals or whether goals have been satisfied. Trigger events and any associated professional service providers are stored in the professional services referral component 514. The professional service providers are professionals such as insurance agents, financial advisors, mortgage brokers, bankers, real estate agents, accountants, and attorneys that provide services. The trigger events are tests for financial transactions, budgets, financial statements, and goals that determine whether a potential need for a professional service exists. The trigger events are pre-defined or customizable such as by the professional service providers. The professional service providers are associated with the trigger events such that the professional service providers provide the services that would result in occurrence of the trigger events. Accordingly, the professional services referral component 514 accesses the balance sheet component 502 or the goals component 512 to evaluate whether the trigger events have occurred. When the trigger events occur, the professional services referral component 514 provides the individual with a referral for the corresponding professional service provider. Accordingly, the software 500 simultaneously manages transactions and provides information regarding an individual's budget, income and cash flow statements, and asset and liability accumulation based upon those financial transactions. Further, the software 500 automatically monitors progress towards and achievement of goals and renders referrals for professional services based upon needs that are manifested by the individual's financial data and goals.

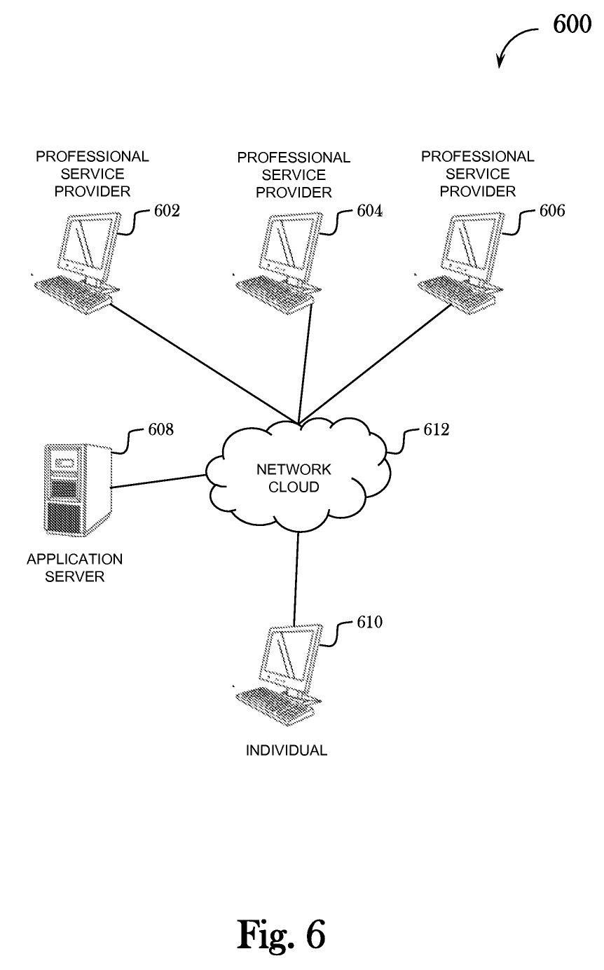

FIG. 6 is a system diagram of financial management and professional referral software being implemented over a computer network, in accordance with an embodiment of the invention. In one embodiment, system 600 includes a professional service provider 602, a professional service provider 604, a professional service provider 606, an application server 608, an individual 610, and a network cloud 612. The application server 608 is a computer that implements embodiments of the invention as described in reference to FIGS. 1-5 supra and is accessible to the individual 610 and the professional service providers 602, 604, and 606 via the network cloud 612. Accordingly, the individual 610 accesses the application server 608 via the network cloud 612 and initializes an account as described in reference to FIG. 1. The professional service providers 602, 604, and 606 also access the application server 608 via the network cloud 612 to associate their professional services with trigger events. The application server 608 analyzes ongoing financial transactions of the individual 610 and provides budget, cash flow statement, income statement, balance sheet, and goal related data for the individual 610. The application server 608 further evaluates financial information and goals associated with the individual 610 and provides professional service referrals to the individual 610 for the professional service providers 602, 604, and 606 upon occurrence of trigger events.

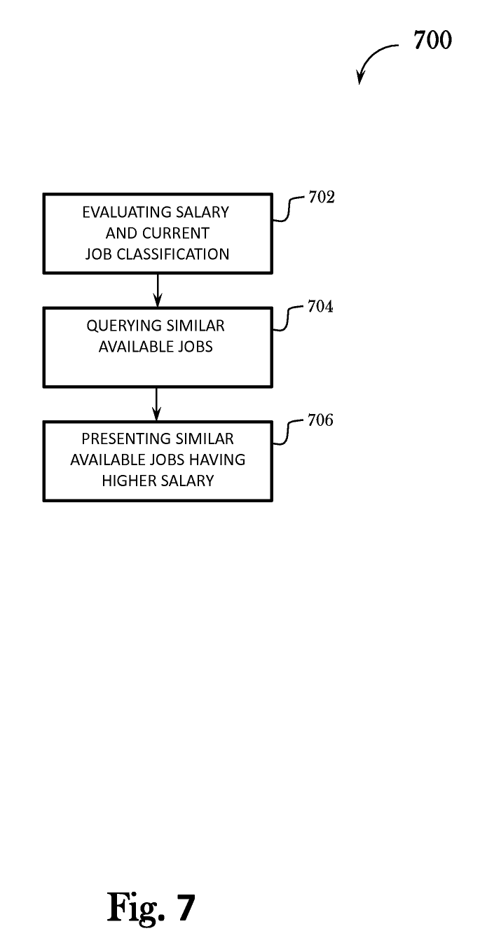

FIG. 7 is a block diagram of a method for providing job referrals in financial management and professional referral software, in accordance with an embodiment of the invention. In one embodiment, method 700 includes evaluating salary and current job classification at block 702, querying similar available jobs at block 704, and presenting similar available jobs having a higher salary at block 706. Method 700 is implemented in coordination with other embodiments disclosed herein. The evaluating salary and current job classification at block 702 includes evaluating the salary information and job classification associated with an account. The querying similar available jobs at block 704 includes searching job listings in databases and directories, such as MONSTER.COM or CRAIGSLIST.COM, to determine whether any available jobs are listed that are similarly classified to the job classification associated with the account. The presenting similar available jobs having a higher salary at block 706 includes presenting the available jobs from the databases and directories that are similarly classified to the current job classification associated with the account and that have a higher salary than the salary associated with the account.

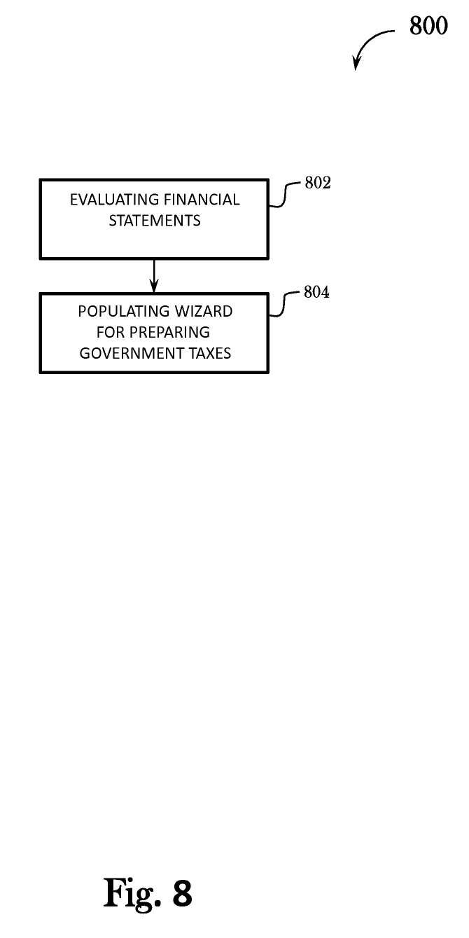

FIG. 8 is a block diagram of a method for populating a wizard for preparing government taxes in financial management and professional referral software, in accordance with an embodiment of the invention. In one embodiment, method 800 includes evaluating financial statements at block 802 and populating a wizard for preparing government taxes at block 804. Method 800 is implemented in coordination with other embodiments disclosed herein. The evaluating financial statements at block 802 includes reviewing debits and credits associated with an account and the populating a wizard at block 804 includes organizing the debits and credits for purposes of preparing tax forms.

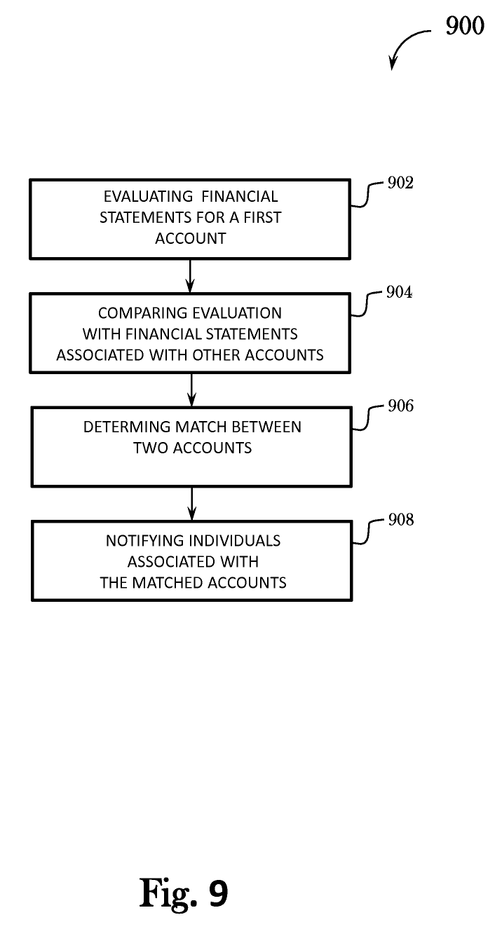

FIG. 9 is a block diagram of a method for matching accounts based on compared financial statements in financial management and professional referral software, in accordance with an embodiment of the invention. In one embodiment, method 900 includes evaluating financial statements for a first account at block 902, comparing the evaluation with financial statements associated with other accounts at block 904, determining a match between two accounts at block 906, and notifying individuals associated with the matched accounts at block 908. Method 900 is implemented in coordination with other embodiments disclosed herein. Evaluating the financial statements for a first account at block 902 includes determining where and what expenditures are being made by an individual associated with the first account. The comparing the evaluation with financial statements associated with other accounts at block 904 includes determining where and what expenditures are being made by other individuals associated with other accounts. The determining a match between two accounts at block 906 includes comparing the expenditures being made by the individual associated with the first account with the expenditures being made by the other individuals associated with other accounts to determine common interests between two individuals. For example, the first account may include a number of coffee purchases at a particular cafe every Sunday morning and one of the other accounts may include a number of coffee purchases at a nearby cafe every Sunday morning. These two accounts may indicate a match because both individuals associated with the accounts appear to enjoy coffee at a similar location at similar times. Matches may be determined on any other basis including similar income levels, dining locations, food purchases, educational expenditures, or patterns of spending. The notifying individuals associated with the matched accounts at block 908 includes providing contact information to or organizing a meeting for the individuals associated with the matched accounts.

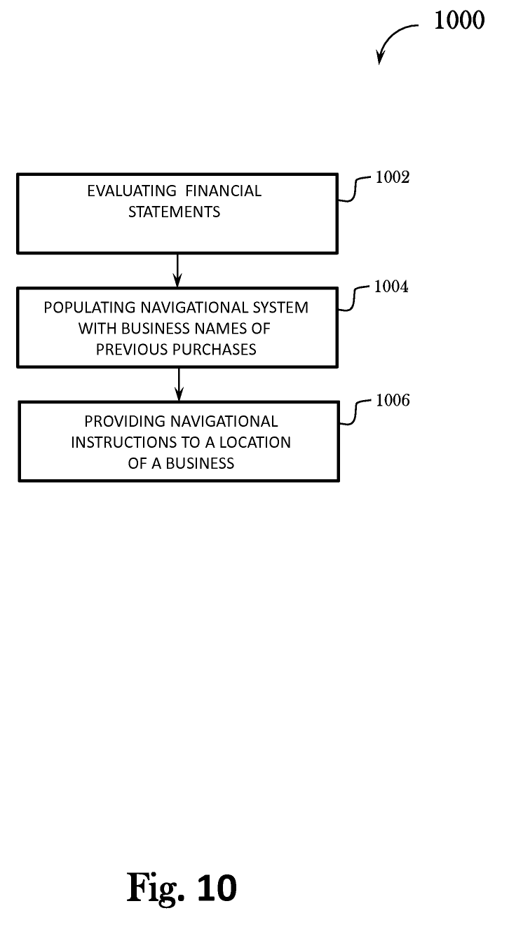

FIG. 10 is a block diagram of a method for populating a navigational system with business names from previous purchases in financial management and professional referral software, in accordance with an embodiment of the invention. In one embodiment, method 1000 includes evaluating financial statements at block 1002, populating a navigational system with locations of previous purchases at block 1004, and providing navigational instructions to at least one of the locations at block 1006. Method 1000 is implemented in coordination with other embodiments disclosed herein. Evaluating financial statements at block 1002 includes identifying business names of previous purchases, such as STARBUCKS for coffee or RED ROBIN for food, that are associated with an account. Populating a navigational system with business names of previous purchases at block 1004 includes inserting the business names identified at block 1002 into navigational software so that they are available for selection. For instance, an individual who is searching for a location to dine that has a past transactional history of dining at RED ROBIN is provided with RED ROBIN as a selection on the navigational system without having to manually enter the text RED ROBIN. Providing navigational instructions to a location of the business at block 1006 includes indicating how to arrive at the nearest location of a selected business name. In one particular embodiment, method 1000 further includes providing information on the amount of money left in a budget for spending at the business name selected.

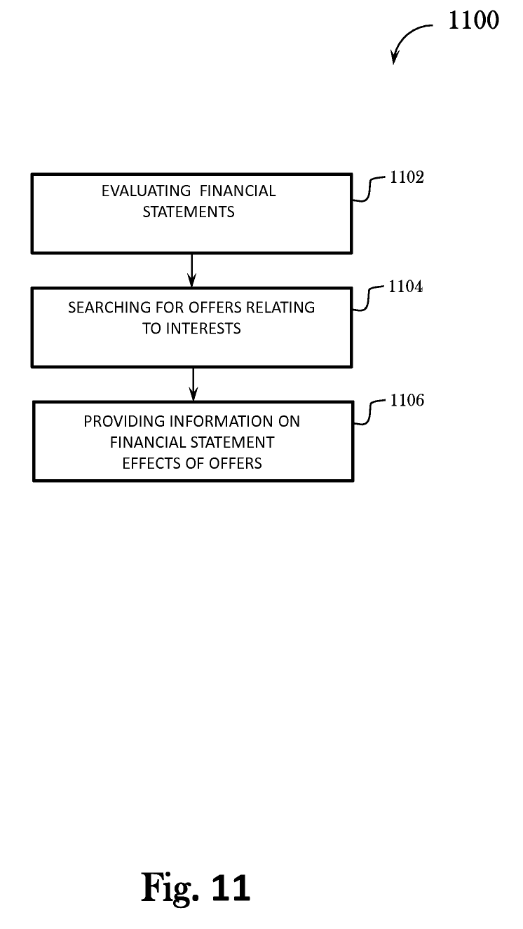

FIG. 11 is a block diagram of a method for presenting offers in financial management and professional referral software, in accordance with an embodiment of the invention. In one embodiment, method 1100 includes evaluating financial statements at block 1102, searching for offers relating to interests at block 1104, and providing information on financial statement effects of offers at block 1106. Method 1100 is implemented in coordination with other embodiments disclosed herein. Evaluating financial statements at block 1102 includes identifying subject matter categories for previous purchases associated with an account, such as media rentals for purchases from HOLLYWOOD VIDEO, golf for purchases with a golf course, or clothing for purchases from MACYS. Searching for offers relating to interests at block 1104 includes searching for discounts, coupons, or other savings with businesses for the subject matter categories identified at block 1102. For instance, searching may include determining whether BLOCKBUSTER or NETFLIX have any attractive discounts, coupons, or other savings for media rentals. Alternatively, searching may include determining whether any local golf courses have special offers for a round of golf. Further, searching may include determining whether NORDSTROMS or GAP have any sales on clothing. If so, these offers are presented to the individual associated with the account for consideration. Providing information on financial statement effects of offers at block 1106 includes detailing how acceptance of the offer would affect the budget, cash flow, and income statement associated with the account.

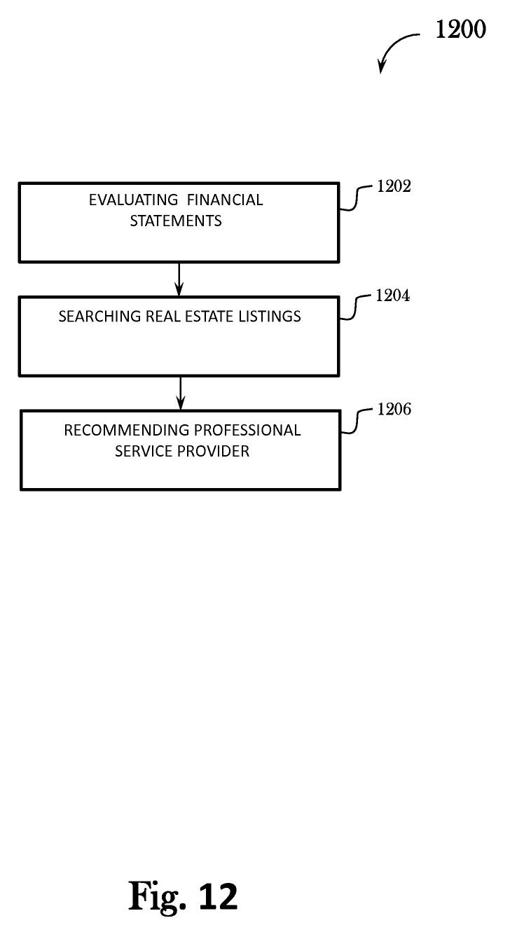

FIG. 12 is a block diagram of a method for presenting real estate listings in financial management and professional referral software, in accordance with an embodiment of the invention. In one embodiment, method 1200 includes evaluating financial statements at block 1202, searching for real estate listings at block 1204, and recommending a professional service provider at block 1206. Method 1200 is implemented in coordination with other embodiments disclosed herein. Evaluating financial statements at block 1202 includes identifying the cash, real estate equity, debt, income amount, and any other relevant factor that is associated with an account and determining the maximum price of a home that can be afforded based upon that information. In one particular embodiment, credit scores are associated with accounts and are usable to determine the maximum loan amount or price of a home that can be afforded. The searching real estate listings at block 1204 includes identifying properties that are for sale that are less than the maximum price of a home that can be afforded. The identified properties are provided to the individual associated with the account. In one particular embodiment, other search criteria such as area, number of bedrooms, number of bathrooms, property acreage, or other similar fact are included when identifying properties. Recommending a professional service provider at block 1206 includes referring a real estate agent as discussed in other embodiments to assist the individual associated with the account in purchasing real estate. In one particular embodiment, recommending a professional service provider at block 1206 further includes referring a loan officer as discussed in other embodiments to assist the individual associated with the account in obtaining a loan for purchasing real estate.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A software application for providing financial management and professional service referrals, the software application comprising the steps of:
establishing an account for an individual;
accepting assets for the individual, the assets being associated with the account;
accepting liabilities for the individual, the liabilities being associated with the account;
defining goals for the individual, the goals being associated with the account;
defining a budget for the individual, the budget being associated with the account;
receiving financial transactions for the individual, the financial transactions being associated with the account;
reconciling the budget with the financial transactions;
reconciling the financial statements with the financial transactions;
reconciling the goals;
summarizing the budget, financial statements, and goals for the individual;
receiving a professional service provider;
associating the professional service provider with a trigger event;
evaluating any of the budget, financial statements, and the goals to determine whether the trigger event has occurred; and
upon occurrence of the trigger event, referring the professional service provider to the individual.

2. The software application of claim 1, further comprising the step of:
associating the goals with any of the assets and the liabilities,
wherein the goals are reconciled with the associated assets and the liabilities.

3. The software application of claim 1, further comprising the step of:
verifying credentials of the professional service provider.

4. The software application of claim 1, further comprising the step of:
upon referring the professional service provider, processing a referral fee.

5. The software application of claim 1, wherein the goals are pre-defined for the individual.

6. The software application of claim 1, wherein the goals are customizable for the individual.

7. The software application of claim 5, wherein the goals include saving a safety reserve amount, eliminating non-auto and non-home related debt, eliminating auto related debt, saving an additional emergency fund amount, saving for retirement, and eliminating home related debt.

8. The software application of claim 1, wherein the financial transactions are automatically electronically received from any of a financial institution and an intermediary.

9. The software application of claim 1, wherein the financial statements include a cash flow statement and a balance sheet.

10. The software application of claim 1, wherein the trigger event is pre-defined.

11. The software application of claim 1, wherein the trigger event is customizable.

12. A software application for providing financial management and professional service referrals, the software application comprising:
a registry component, the registry component configurable to accessing financial transactions for an account associated with an individual;
a budget component, the budget component configurable to storing a budget for the account, the budget component configurable to reconciling the budget with the financial transactions and providing data on the budget;
a cash flow statement component, the cash flow statement component configurable to reconciling a cash flow statement with the financial transactions and providing data on the cash flow statement;
a balance sheet component, the balance sheet component configurable to storing assets and liabilities for the account, the balance sheet component configurable to reconciling the assets and liabilities with the financial transactions and providing data on the assets and liabilities;
a goals component, the goals component configurable to storing goals for the account, the goals component configurable to reconciling the goals and providing data on the goals; and
a professional services referral component, the professional services referral component configurable to
receiving a professional service provider,
associating the professional service provider with a trigger event,
evaluating any of the budget, cash flow statement, balance sheet, and the goals to determine whether the trigger event as occurred, and
upon occurrence of the trigger event, referring the professional service provider to the individual.

13. The software application of claim 12, wherein the goals are associated with any of the assets and liabilities and wherein the goals are reconciled with the associated assets and liabilities.

14. The software application of claim 12, wherein the professional services referral component is further configurable to verifying credentials of the professional service provider.

15. The software application of claim 12, wherein the professional services referral component is further configurable to processing a referral fee on referring the professional service provider.

16. The software application of claim 12, wherein the goals are pre-defined for the individual.

17. The software application of claim 12, wherein the goals are customizable for the individual.

18. The software application of claim 12, wherein the financial transactions are automatically electronically accessed from any of a financial institution and an intermediary.

19. The software application of claim 12, wherein the trigger event is pre-defined.

20. The software application of claim 12, wherein the trigger event is customizable.
